(19) United States
(12) Patent Application Publication
(10) Pub. No.: US 2012/0224923 A1
(43) Pub. Date: Sep. 6, 2012

(54) DEVICE FOR COVERING AND PROTECTING BURIED PIPES OR CABLES

(76) Inventor: Yannick Joubeaux, Saint Marc Jaumegarde (FR)

(21) Appl. No.: 13/394,315

(22) PCT Filed: Aug. 19, 2010
(86) PCT No.: PCT/FR2010/051735

§ 371 Date: May 18, 2012

(30) Foreign Application Priority Data
Sep. 4, 2009 (FR) 09/56034

(51) Int. Cl. F16L 57/00

(52) U.S. Cl. 405/157

(57) ABSTRACT

The invention relates to a device for covering and protecting buried pipes or cables, including a substantially planar plate (2) made of a single piece of synthetic material, the plate having a first surface (3) and a second surface (4) opposite the first surface, the plate (2) comprising complementary assembly means (5-8) at at least two of the edges thereof, which are arranged so as to enable the assembly of two adjacent plates, the complementary assembly means being designed to enable two adjacent plates to be hinged about an axis substantially perpendicular to the plane of the adjacent plates. The plate comprises a plurality of through-openings (9) leading onto the first and second surfaces (3, 4) of the plate, respectively.

### TECHNICAL FIELD

The present invention concerns a device for covering and protecting buried pipes or cables.

### BRIEF DISCUSSION OF RELATED ART

To prevent the degradation of buried pipes or cables during earthwork operations, it is known to use covering and protecting devices embedded in the earth and arranged above buried pipes or cables.

These covering devices firstly allow the protection of the buried pipes or cables against deteriorations caused by the scoop of a mechanical digger, and secondly they warn operators of the presence of pipes or cables so that the digger does not dig deeper into the soil at this point.

One first known solution consists of forming a covering and protective device formed of a cover plate in reinforced concrete. This type of cover device has sufficient mechanical strength to protect buried pipes or cables against deteriorations caused by the scoop of a mechanical digger.

However, one disadvantage of this type of cover plate lies in the fact that it is heavy and cumbersome. As a result it is difficult to handle.

In addition, metal reinforcements incorporated in the cover plate in reinforced concrete may interfere with electric or electromagnetic signals emitted by a device for detecting and identifying buried elements, and hence prevent satisfactory identification of a pipe buried by an operator. There are resulting risks of deterioration of the buried pipe at the time of subsequent earthwork.

A second known solution consists of forming a covering and protective device comprising a protective plate which, at two opposite edges, has means for conjugate assembling arranged to allow the assembly of two adjacent protective plates, the conjugate assembly means being designed to allow hinging between two adjacent protective plates about an axis perpendicular to the plane of the protective plates.

Said covering and protective device allows the adjustment of the orientation between adjacent protective plates and hence the ensured continuity of protection of the buried pipes or cables, including at bends.

However, one disadvantage of these two types of cover plates lies in the fact that they promote the retaining of underground water which may lead to soil creep.

### BRIEF SUMMARY

The present invention sets out to overcome these disadvantages.

The technical problem underlying the invention therefore concerns providing a cover device which is of simple, economic and lightweight structure whilst reducing the risk of soil creep.

For this purpose the present invention concerns a covering and protective device for buried pipes or cables, comprising a substantially planar plate made in one piece in synthetic material, the plate having a first surface and a second surface opposite the first surface, the plate comprising first assembly means arranged at least at one first edge of the plate and second assembly means, conjugate with the first assembly means, arranged at least at a second edge of the plate, the first assembly means of a plate being intended to cooperate with the second assembly means of an adjacent plate so as to allow the assembly between two adjacent plates, the first and second assembly means being designed to allow hinging between two adjacent plates about an axis substantial perpendicular to the plane of the adjacent plates, characterized in that the plate comprises a plurality of through orifices respectively opening into the first and second surfaces of the plate.

The presence of through orifices allows the evacuation of groundwater through the cover plate which reduces the risks of soil creep.

In addition, the presence of the through orifices facilitates the passing of electric or electromagnetic signals emitted by a detection and identification device, and hence improves the locating of buried pipes and/or cables.

In addition, if the covering and protective device is used to cover gas pipes, the presence of the through orifices prevents the accumulation of gases underneath the plate in the event of a leak.

The use of synthetic material to form the plate allows a cover device to be obtained that is lightweight and hence easy to handle. In addition, the use of synthetic material allows the cover device to be formed by moulding and hence to obtain very low manufacturing costs.

Also, the fact that the cover device is made in synthetic material avoids the interference of electric or electromagnetic signals emitted by a device detecting and identifying buried elements, and hence does not jeopardize the detection and identification of buried pipes.

The fact that the cover device is made in synthetic material also makes it possible, using a suitable synthetic material, to obtain a brightly coloured cover. Said covering device, through its bright colouring, can form visual warning means for an operator during earthwork operations. On this account, it is no longer necessary to make provision for additional alert systems of warning mesh netting type, which allows a reduction in the costs of protecting buried pipes or cables.

Preferably the through orifices are regularly distributed on the surface of the plate.

According to one characteristic of the invention, the first and second surfaces of the plate, at least over part of their surface, comprise projections. Advantageously, each projection is substantially shaped in the form of a cross. Preferably the projections are regularly distributed on each surface of the plate.

The presence of projections on at least one of the surfaces of the plate improves the resistance of the plate, in particular at the bottom of the trench intended to receive the plate, and further reduces the risks of soil creep.

Preferably the plate comprises grasping means arranged at each of the edges thereof. The grasping means advantageously comprise a plurality of knobs extending substantially perpendicularly from at least one of the first and second surfaces of the plate. With these arrangements, it is possible to improve the grasping of the plate by an operator.

Preferably the first and second assembly means are press-fitting means. The first assembly means comprise at least one press-fit stud arranged on one of the edges of the plate, and the second assembly means comprise at least one press-fit orifice arranged on another edge of the plate, the press-fit stud and the press-fit orifice being designed so as to allow hinging between two adjacent plates about the hinge axis. Preferably the press-fit stud is designed to ensure the removable assembling of two adjacent plates. For example, it comprises several elastically deformable tongues.

According to one embodiment of the invention, the plate is substantially rectangular and firstly has first and second assembly means respectively arranged at its first second longitudinal edges and arranged to allow assembly between two adjacent plates disposed side by side, and secondly first and second assembly means respectively arranged at its first and second transverse edges and arranged to allow the assembling between two adjacent plates disposed one after the other.

Preferably the plate comprises through holes at each of its corners. These arrangements, via adapted rods mounted in the through holes, allow the ensured continuity of protection of the buried pipes or cables when they are buried along bends having a low radius of curvature.

Advantageously the first surface of the cover plate comprises means for identifying buried pipes or cables, the identification means preferably being wording printed on the first surface of the plate. The wording may for example be of the type <<warning gas>> or <<high pressure gas>>.

Preferably the cover plate comprises bevelled edges. These arrangements can prevent the cover plate from being caught by the scoop of a mechanical digger during earthwork operations.

The present invention also concerns a cover assembly comprising at least two cover devices according to the invention assembled onto each other.

### BRIEF DESCRIPTION OF THE DRAWINGS

At all events, the invention will be well understood with the help of the following description given with reference to the appended schematic drawing illustrating a non-limiting example of one embodiment of this cover device.

FIG. 1 is a perspective, overhead view.

FIG. 2 is a perspective, underside view.

FIGS. 3 and 4 are partial, perspective underside views on an enlarged scale.

FIG. 5 is a perspective view on an enlarged scale of one of the projections extending over the first and second surfaces of the plate.

FIG. 6 is a perspective, cross-sectional view showing the conjugate assembly means of two adjacent cover devices.

FIGS. 7 to 11 are overhead views of different cover assemblies according to the invention.

### DETAILED DESCRIPTION

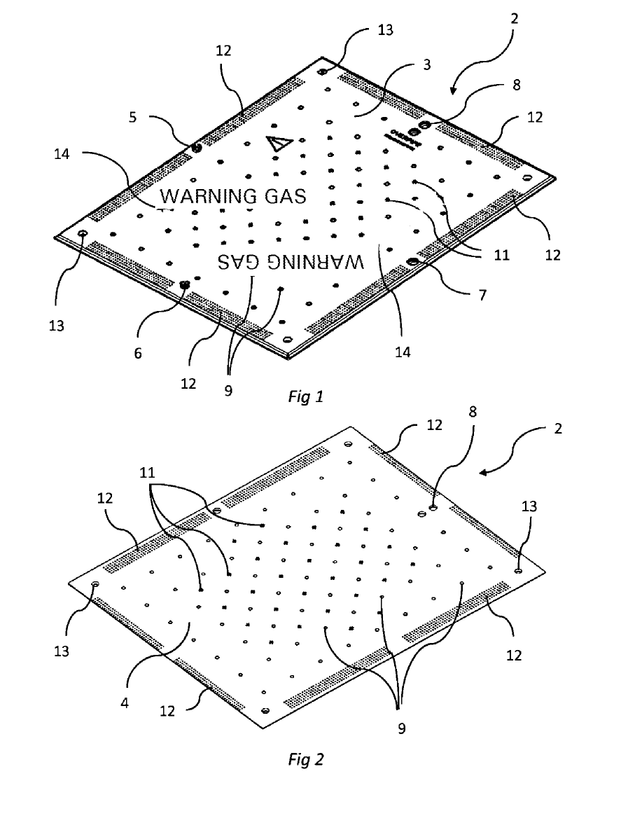

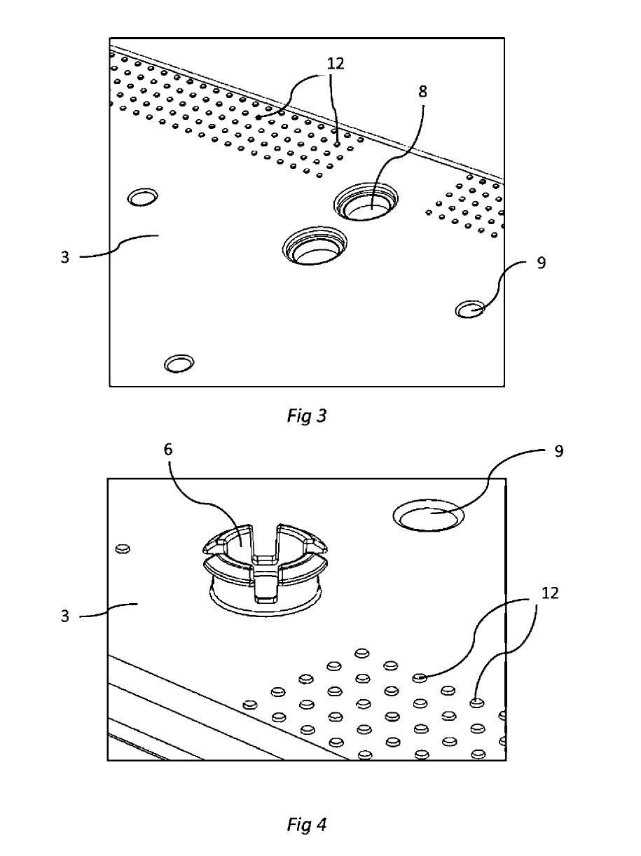

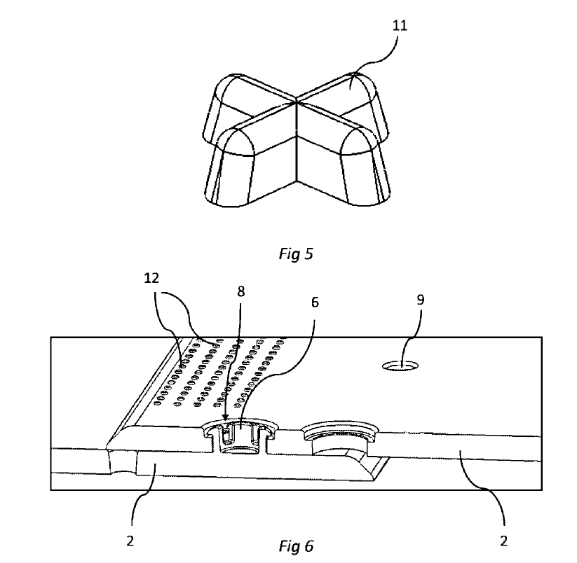

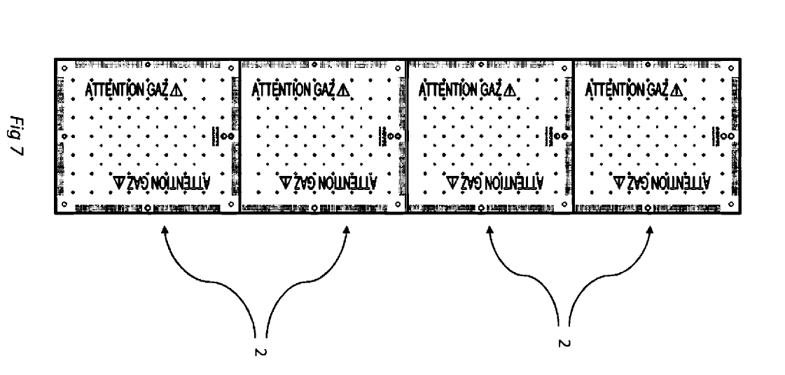

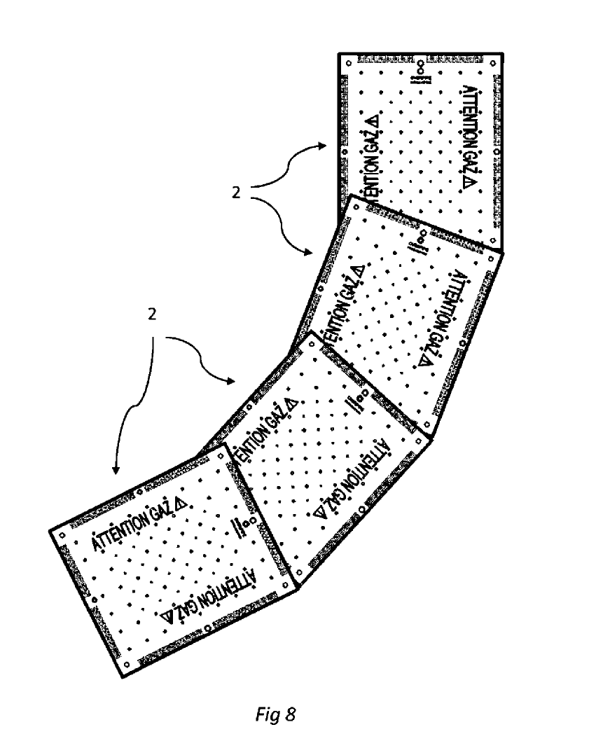

FIGS. 1 and 2 illustrate a covering and protective device for buried pipes or cables, such as fluid transport pipes or electric or telecommunications cables.

The cover device is formed of a substantially planar cover plate 2 made in a single piece in synthetic material. The cover plate 2 is substantially rectangular. The cover plate 2 has a first surface 3 and a second surface 4 opposite the first surface 3.

The cover plate 2, at its longitudinal and transverse edges, has conjugate assembly means arranged to allow the assembly between two adjacent plates respectively arranged side by side and one after the other. These conjugate assembly means are formed by press-fitting and are designed to allow hinging between two adjacent plates about an axis substantially perpendicular to the plane of the adjacent plates.

It is first to be noted that the conjugate assembly means located at the longitudinal edges of the cover plate 2 are identical to those located at the transverse edges thereof.

The conjugate assembly means comprise a press-fit stud 5 arranged on one of the longitudinal edges of the plate, a press-fit stud 6 arranged on one of the transverse edges of the plate, a press-fit orifice 7 arranged on the other longitudinal edge of the plate, and a press-fit orifice 8 arranged on the other transverse edge of the plate. The press-fit studs 5; 6 are intended to cooperate respectively with the press-fit orifices 7, 8 of an adjacent cover plate.

The cover plate 2 further comprises a plurality of through orifices 9 respectively opening into the first and second surfaces of the plate, the through orifices 9 being regularly distributed over the surface of the cover plate 2. Each through orifice 9 extends substantially perpendicular to the plane of the cover plate 2.

The first and second surfaces 3,4 of the plate 2, on at least part of the surface, comprise projections 11 substantially in the shape of a cross, the projections 11 being regularly distributed over each surface 3, 4 of the plate 2.

The cover plate 2 also comprises grasping means arranged at each of its edges. The grasping means preferably comprise a plurality of knobs 12 extending substantially perpendicularly from the first and second surfaces 3, 4 of the plate.

The plate additionally comprises through holes 13 at each of its corners.

Advantageously the first surface 3 of the cover plate comprises means for identifying buried pipes or cables, the identification means preferably being wording 14 printed on the first surface of the plate.

A description will now be given of the method for covering a pipe, for example a gas or fluid pipe, with a cover assembly comprising several cover plates 2.

As shown in FIG. 7, the covering method comprises the following steps of:
a) digging a trench in the ground using a mechanical earthwork device;
b) arranging the pipe in the trench;
c) covering the pipe with a layer of earth;
d) positioning the cover plate 2 in the trench substantially horizontally above the pipe;
e) assembling a cover plate 2 onto the cover plate previously positioned in the trench, by causing the cooperation between their conjugate assembly means arranged at their transverse edges;
f) repeating step e) several times so as to form a row of cover plates 2 arranged one after the, that is of sufficient length to cover the entire pipe.

If the pipe is of large diameter, the covering method also comprises the following step of:
g) forming at least one second row of cover plates 2 arranged one after the other, each cover plate 2 of the first row being assembled onto the adjacent cover plate of the second row by causing cooperation between their conjugate assembly means arranged at their longitudinal edges.

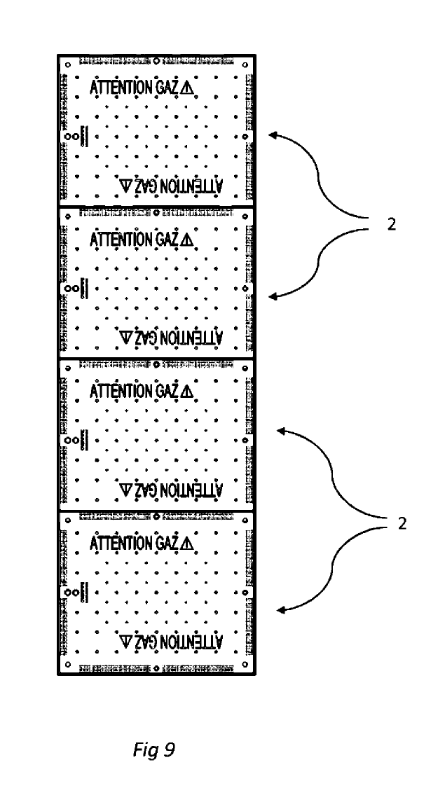

According to one variant of embodiment of the covering method, step e) comprises assembling a cover plate 2 onto the cover plate previously positioned in the trench by causing the cooperation between their conjugate assembly means arranged at their longitudinal edges. On this account, it is possible to obtain a cover assembly such as illustrated in FIG. 9.

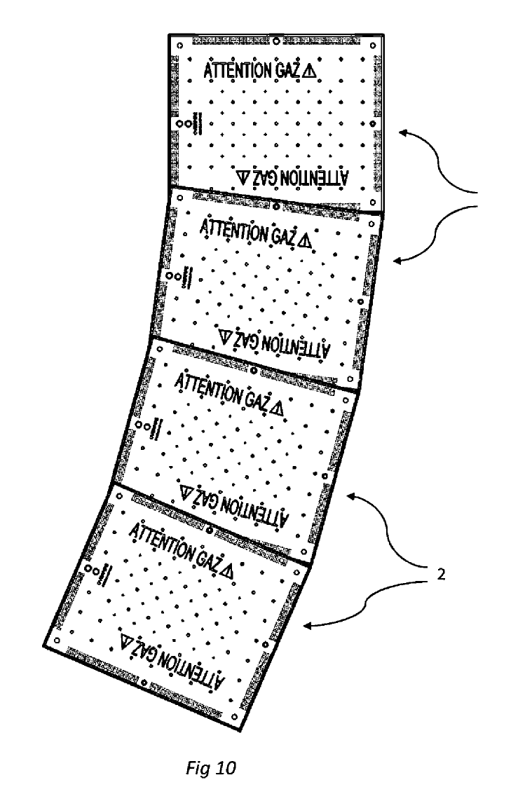

As specified above, the conjugate assembly means are designed to allow hinging between two adjacent plates about an axis substantially perpendicular to the plane of the adjacent plates. On this account, it is also possible to obtain a cover assembly such as illustrated in FIG. 10.

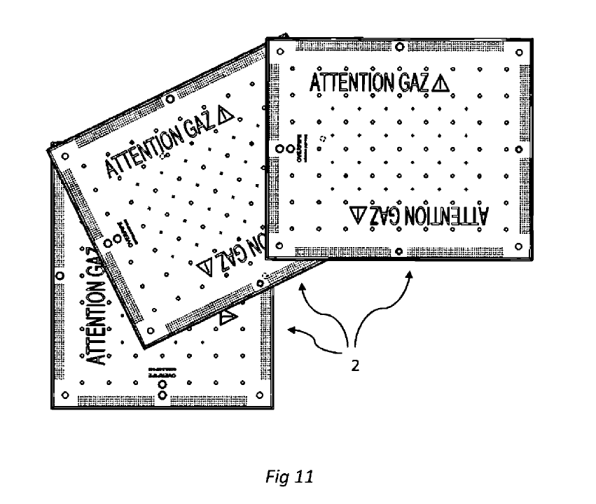

Via adapted, substantially cylindrical rods mounted in the through holes 13, it is further possible to obtain a cover assembly such as illustrated in FIG. 11.

Evidently the invention is not limited to the sole embodiment of this cover device described above as an example, but on the contrary encompasses all variants of embodiment.

1. A device for covering and protecting buried pipes or cables, comprising a substantially planar plate made in a single piece in synthetic material, the plate having a first surface and a second surface opposite the first surface, the plate comprising first assembly means arranged at least at one first edge of the plate, and second assembly means conjugate with the first assembly means, arranged at least at a second edge of the plate, the first assembly means of a plate being intended to cooperate with the second assembly means of an adjacent plate so as to allow the assembly between two adjacent plates, the first and second assembly means being designed to allow hinging between two adjacent plates about an axis substantially perpendicular to a plane of the adjacent plates, wherein the plate comprises a plurality of through orifices respectively opening into the first and second surfaces of the plate.

2. The device according to claim 1, wherein the first and second surfaces of the plate comprise projections.

3. The device according to claim 2, wherein each projection is substantially in a shape of a cross.

4. The device according to claim 1, wherein the plate comprises grasping means arranged at each of its edges.

5. The device according to claim 4, wherein the grasping means comprise a plurality of knobs extending substantially perpendicularly from at least one of the first and second surfaces of the plate.

6. The device according to claim 1, wherein the first and second assembly means are achieved by press-fitting.

7. The device according to claim 6 wherein the first assembly means comprise at least one press-fit stud arranged on one of the edge of the plate, and the second assembly means comprises at least one press-fit orifice arranged on another edge of the plate, the press-fit stud and press-fit orifice being designed so as to allow hinging between two adjacent plates about a hinge axis.

8. The device according to claim 1, wherein the plate is substantially rectangular, and firstly has first and second assembly means respectively arranged at first and second longitudinal edges and arranged to allow the assembly between two adjacent plates disposed side by side, and secondly first and second assembly means respectively arranged at first and second transverse edges and arranged to allow the assembly between two adjacent plates disposed one after the other.

9. The device according to claim 8, wherein the plate comprises through holes at each of its corners.

10. The device according to claim 1, wherein the first surface of the plate comprises means for identifying buried pipes or cables, the identification means comprising wording printed on the first surface of the plate.

11. A covering and protective assembly, comprising at least two covering and protective devices according to claim 1 assembled onto each other.
